(19) United States
(12) Patent Application Publication
(10) Pub. No.: US 2006/0016954 A1
(43) Pub. Date: Jan. 26, 2006

(54) Visual aid for aligning a towing vehicle and a trailer hitch

(76) Inventor: Richard Dale Saxwold, Nocona, TX (US)

Correspondence Address: Georgetown Patent Services, P.O. Box 5053, Georgetown, TX, 78627, US

(21) Appl. No.: 10/898,824

(22) Filed: Jul. 24, 2004

(51) Int. Cl. B60R 1/02

(52) U.S. Cl. 248/467

(57) ABSTRACT

Methods and apparatus for assisting the operator maneuvering a towing vehicle backward to align a first trailer hitch components on the rear of the towing vehicle and on the forward portion of a trailer by directing a field of view comprising an image of the trailer hitch components to the line of sight of an observer sitting in the driver's seat of the towing vehicle. Visual aid devices of the present invention include a mirror, a magnet for removably attaching visual aid device to a selectable location on either the towing vehicle or the trailer, and a support for adjustably affixing the mirror to the magnet. Mirror is movably positionable, in relationship to the magnet, within a fixed range of position options and the angle of the mirror axis in relationship to the magnet axis is adjustable within a fixed range of angle options.

### FIELD OF THE INVENTION

The present invention relates to, a device for facilitating trailer hitch alignment, and in particular a visual aid apparatus for visually assisting an operator of a towing vehicle in maneuvering the towing vehicle in order to align a first trailer hitch component on the rear of a towing vehicle with a second trailer hitch component on a trailer.

### BACKGROUND OF THE INVENTION

As a towing vehicle is maneuvered backward so that the trailer hitch component on the rear bumper is closely adjacent and vertically aligned with the hitch component on the trailer, a tool that facilitates the driver of the towing vehicle to observe the area in the vicinity of either one of the hitch components greatly improves the drivers ability to quickly and accurately position of the towing vehicle. There is a need for such a tool that is easily installed and removed. Furthermore, there is a need for a tool with flexibility, presently not available with similar prior art tools, that permits the tool to be readily installed on a wide range of diverse trailers and towing vehicles and then removed when not in use. This capacity is particularly important for some markets, such as mail order or Internet sales, where the tools may need to be purchased before having opportunity to try it and verify that it works with the particular towing vehicle or trailer.

### BRIEF DESCRIPTION OF THE DRAWINGS

The invention may best be understood by referring to the following description and accompanying drawings that are used to illustrate embodiments of the invention. In the drawings:

FIGS. 1A through 1D illustrate an embodiment of a visual aid device of the present invention and FIGS. 1E and 1F show alternate suitable implementations;

FIGS. 2A through 2E depict visual aid embodiments of the present invention;

FIGS. 3A through 3C illustrate an visual aid embodiment of the present invention that is comprised of an integrated warning mechanism capable of warning an operator of a towing vehicle that the towing vehicle has come into close proximity to the trailer; and

FIGS. 4 and 5 show examples of visual aids of the present invention installed in a manner to assist an operator of a towing vehicle maneuvering the vehicle backwards into correct alignment with a trailer.

### DETAILED DESCRIPTION OF THE INVENTION

Visual aid devices of the present invention are well suited for assisting an operator of a towing vehicle maneuvering the towing vehicle backwards to interconnect a trailer or the like. Devices of the present invention may be installed and removed from magnetic-sensitive planar surfaces, which are commonly found on towing vehicles, trailers and the like allowing visual aid device be a effective with a wide range of trailer types. Aspects of the present invention provide for easier installation and removal. Some aspects improve the capability of the visual aid to remain in place after being installed and other aspects provide for the visual aid to be secured to a more diverse range of surface types and orientations. Furthermore, certain aspects of the present invention provide for increased configuration options for positioning the mirror that improves the ability for visual aids of the present invention to be effective in a wider range of towing situations than similar prior art devices.

In the following description, numerous specific details are set forth to provide a thorough understanding of the invention. However, it is understood that the invention may be practiced without these specific details. In other instances, well-known mechanical components, electrical components, structures and techniques have not been shown in detail in order not to obscure the invention. Components referred to with reference designators consisting of numerals followed by a letter, are generally similar to the components referred to by the corresponding numerals, but vary slightly in function or physical structure as described in the associated description.

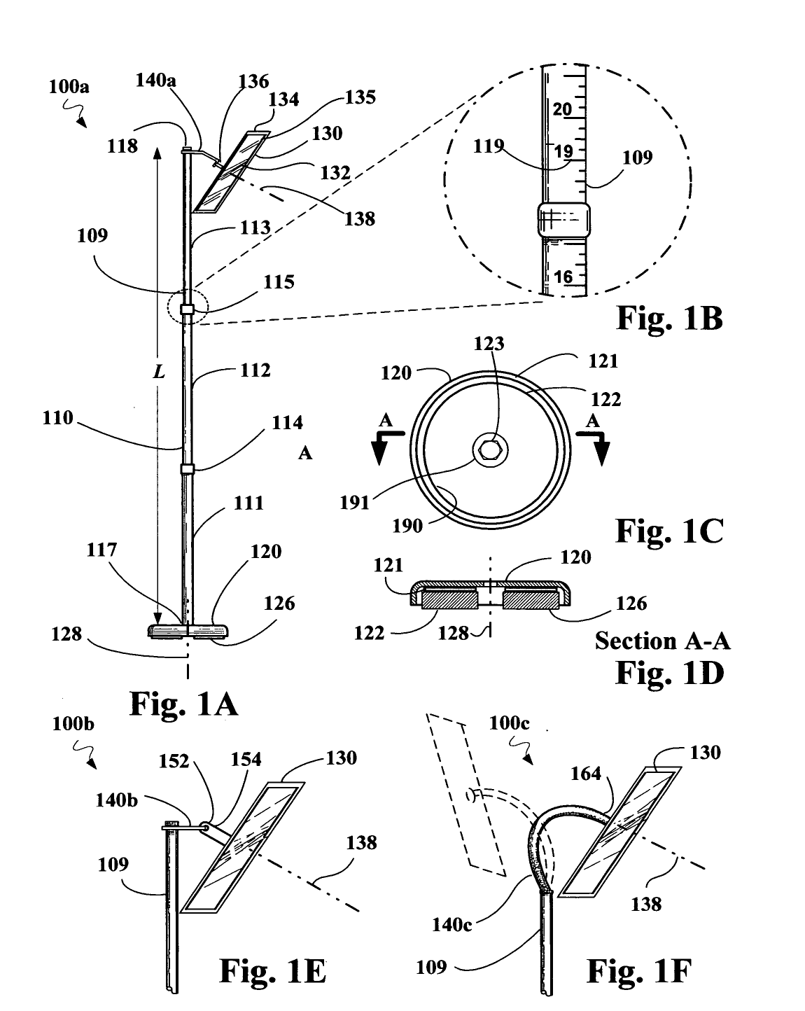

FIGS. 1a through 1f depict various alternate embodiments of a visual aid device 100a of the present invention. A visual aid 100a of the present invention is comprised of a mirror 130 that is pivotally attached to a support 110. Support 110 is comprised of a base 120 that may be removably secured to any of a wide assortment of towing vehicles trailers and the like. In situations where an operator of a towing vehicle must back up the towing vehicle to mechanically interconnect a trailer to the rear of the towing vehicle, visual aid 100a may be installed in a manner that allows the mirror 130 to direct a selected field of view, of an area that is generally located behind the towing vehicle, to the line of sight of an observer sitting in the drivers seat of the towing vehicle.

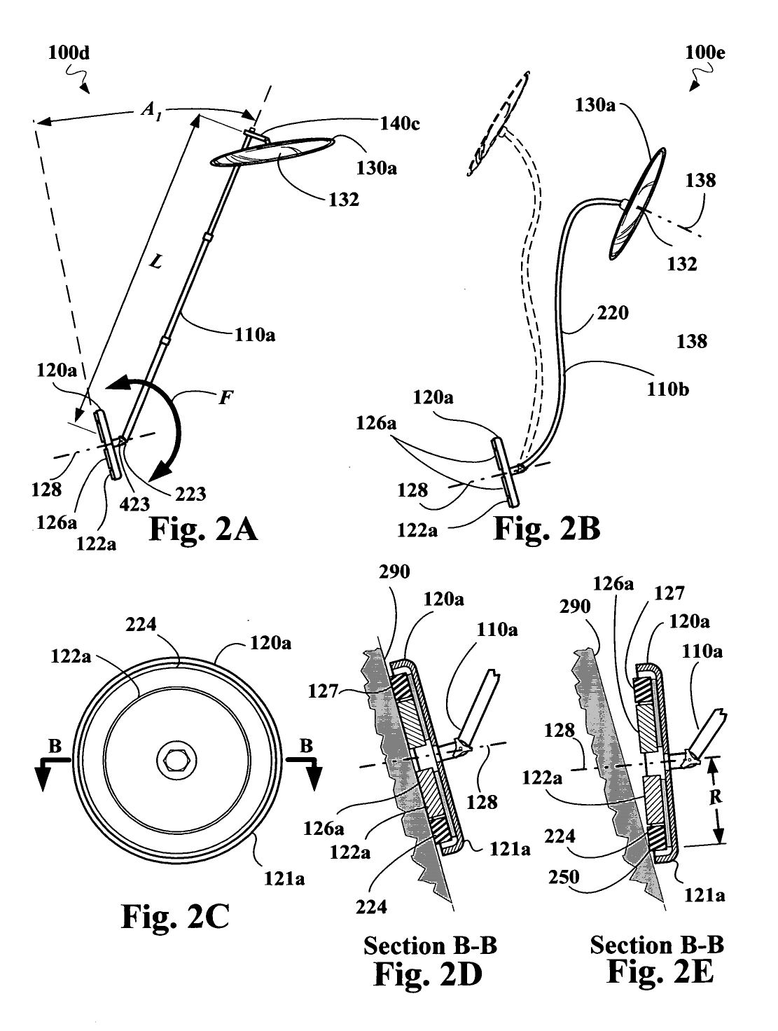

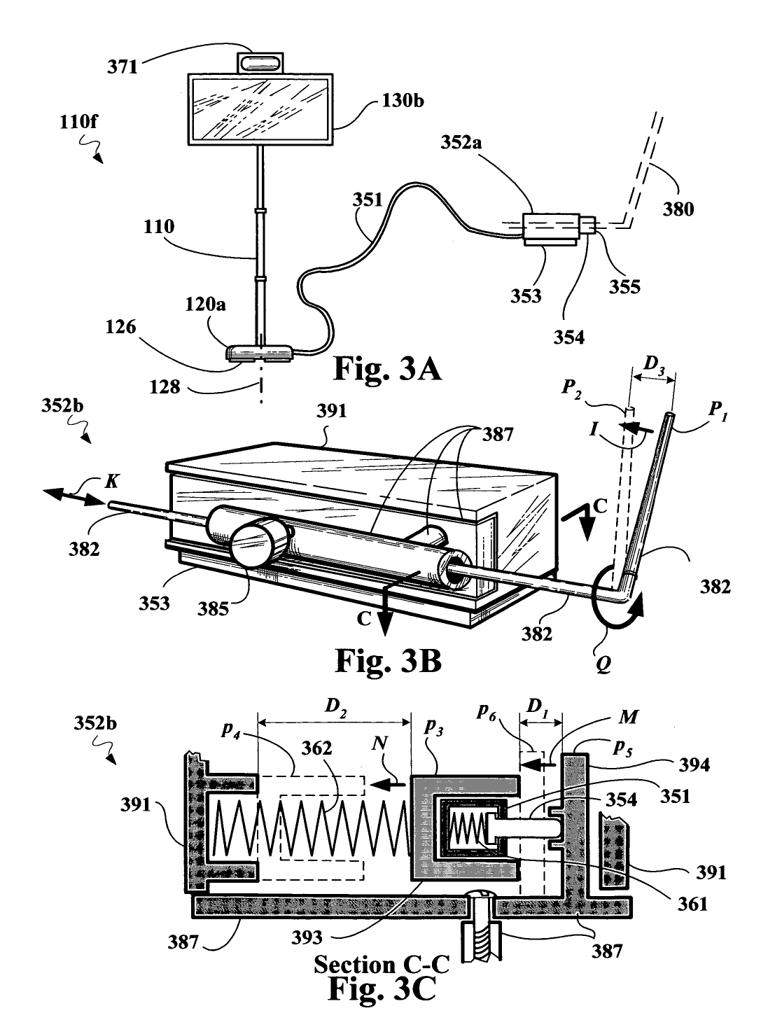

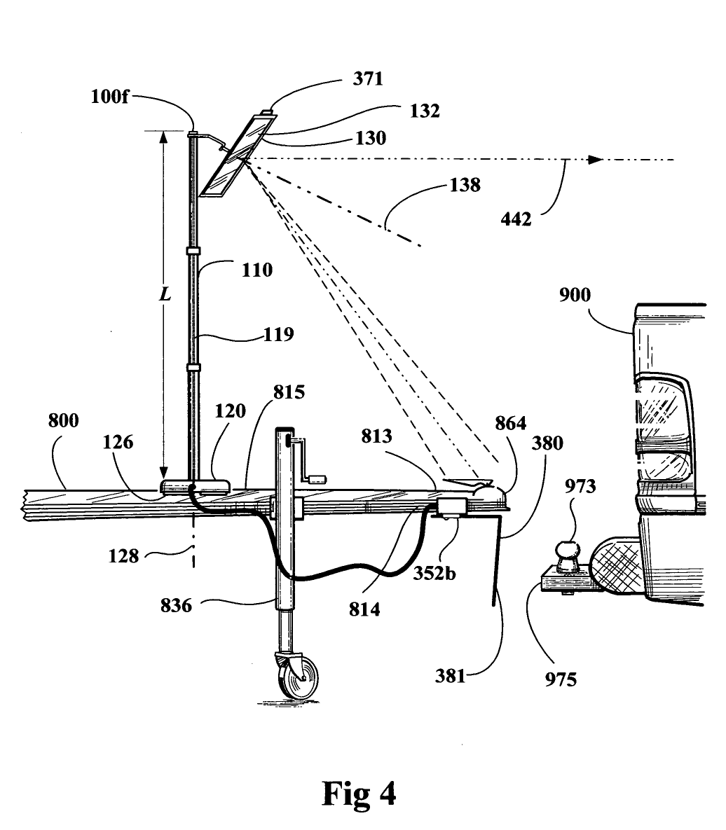

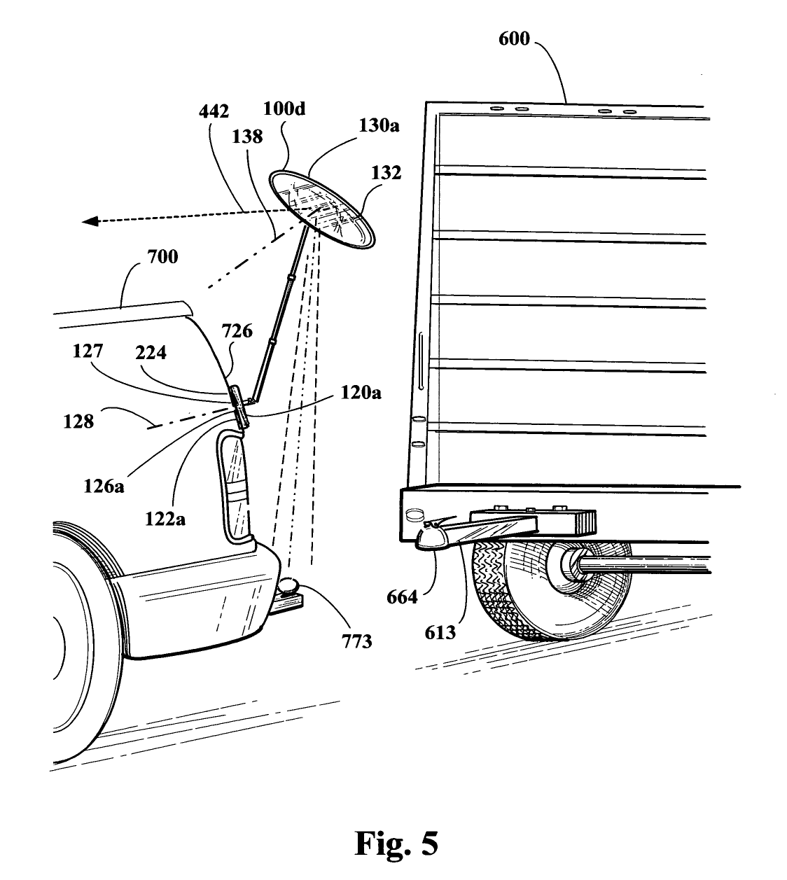

Mirror 130, in the disclosed embodiment shown in FIGS. 1A, 1E, and 1F, is comprised of a thin, rectangular, light-weight aluminum frame 134 that holds a thin, flat, rectangular mirrored glass 135 with an exposed reflective surface 132. Exemplary embodiment shown in FIGS. 1A through 1F, as well as FIGS. 3 and 4, which will be discussed later in this disclosure, utilize a mirror 130 with a flat rectangular reflective surface 132 that is about 7.5 inches by 5.5 inches. Exemplary embodiments shown in FIGS. 2A through 2B and FIG. 5 (these figures are discussed in later in disclosure) employ a round mirror 130a with a 6 inch diameter reflective surface 132 that is convex to provide about 200% magnification. For purposes of this disclosure, a mirror axis 138 is defined as a line intersecting a centrally located point on the (round, rectangular or other shaped) reflective surface 132 of mirror 130 and lying perpendicular to the portion of the mirror in the vicinity of the intersecting point.

Visual aid devices of the present invention tend to be highly elongated and removably attached and thus small, light-weight mirrors advantageously diminish the inherent tendency of visual aid to tip in many towing situations due to external forces such as wind or gravity acting on the overall device. Embodiments of a visual aid consistent with the present invention may also include mirrors comprised primarily of plastic. The size, shape, and composition of suitable mirrors may be selected based considerations that include cost, weight, ruggedness, quality, and magnification of the reflective surface 132. In general, for use in towing situations where the mirror is located more than 5 feet away from the observer, a flat reflective surface 132, with an area that exceeds a 4 inch diameter, is minimally sufficient. It is advantageous to employ larger mirrors, but the maximum size is generally limited by considerations involving weight.

The base 120, as depicted in FIGS. 1A through 1F and FIG. 4, provides for removable attachment of visual aid 100a to a magnetic-sensitive surface such as commonly located on a trailer or towing vehicle. FIG. 1A depicts a side view of base 120, FIG. 1C illustrates a lower view of base 120, and FIG. 1D shows a breakaways section of section A-A of FIG. 1C.

Base 120 is comprised of a magnet 122 having a thin, generally cylindrical shape defining a central axis, formed with a coaxially located central cylindrical void 128. Base 120 is also comprised of a generally circular, thin steal cover 121, which is fixedly attached via a bold 123 to the lower end 117 of support 110. Magnet 122 and cover 121 each have an upper and a lower planar surface. The upper planar surface of the magnet 122 is coaxially affixed the lower planar surface of the cover 121. As shown in FIG. 1C and 1D, the lower exposed planar surface 126 of magnet 122 includes an area that is located essentially in a plane lying traverse with the central axis 128 of magnet 122 and is bounded by an outer 191 and an inner circle 190.

Visual aid 100a may be removably attached to a towing vehicle, trailer or the like, by placing the lower exposed planar surface 126 of base 120 adjacent to a selected target attachment surface to engage in a magnetic bond. When attached to a target surface, the magnet axis 128 lies perpendicular to the attachment surface. Visual aid 110a may be selectively rotated about base axis 128 to select the desired angular orientation of visual aid 100a. One advantage of being able to select the angular orientation is to provide increased installation configuration options such as allowing visual aid 100a to be positioned to the side of the hitch component, for example, on a bumper of a towing vehicle.

Suitable magnets 122 are selected based on the particular application and considerations such as cost, rated pull force, and geometry. High pull forces provide the advantage of increased attachment force, but lower pull forces allow the visual aid to be removed easier and are less likely to damage painted surfaces. For many applications, the shape of thin and wide magnets 122, such a magnet with a thickness to outer diameter ratio that is approximately 1 to 10 or more, advantageously provides the base 120 with a wide radius that tends to be more resistant to tipping compared to narrower magnets. Magnets 122 with outer diameters that are greater than 2.5 inches but less then 4 inches and have a rated nominal pull force generally in the range of 40 lb to 160 lb may suitable for use with many trailers and towing vehicles.

Support 110 further includes a telescoping portion 109 that is comprised of three strait tubular sections 111-113 arranged coaxially end-to-end. The diameter of sections 111-113 are progressively smaller to allow each of the two upper sections 112, 113 to slide into the next lower, adjacent, section in a telescoping fashion. Two adjustable locking nuts 114, 115 connect the center section 112 to adjacent sections 111, 113. When each of the two locking nuts 114 and 115 are in an unlocked position, the support 110 is telescopically adjustable through a range of extended positions. The two locking nuts 114, 115 may be rotated from the unlocked position to a locked position to fix the length L of the support 110. The range of available lengths L of support 110 is selected for visual aid 100a based on considerations that may include, overall weight of visual aid 100a and the intended flexibility of visual aid 100a to be effective in a wide range of diverse situations. In the particular exemplary embodiment shown in FIGS. 1A through 1F, and FIG. 4, each of the three tubular sections 111-113 is about 18 inches long and the length L may be selected from the predefined available range of 20 inches to 56 inches. Tubular sections 111-113 may be comprised of aluminum, plastic, steel, or other materials selected based on concerns including the manufacturing cost, the weight of the mirror 130 and the desired overall ruggedness of the visual aid 100a.

Mirror 130, shown in FIG. 1A, is pivotally affixed to the upper end 118 of support 110 via a ball-and-socket pivotal connector 136. A bracket 144 is affixed on one end to the top of the telescoping portion 109 and the other end extends 1.25 inches laterally from the telescoping portion 109 and then bends 30° toward the base 120 to attach to the ball-portion of connector. The socket-portion of connector 136 is affixed, centrally, to the backside of mirror frame 134. The axis of the ball and socket connector 136 deviates from the longitudinal axis of the telescoping portion 109 by approximately 60°. The axis 138 of mirror 130 may be adjusted within a predefined range to deviate as much as 30° in from the longitudinal axis of the ball and socket connector 136.

Alternate embodiments of a visual aid 100b, 100c of the present invention are shown in FIGS. 1E and 1F. Visual aids 100b, 100c employ mechanisms for pivotally attaching mirror 130 to support 110 that provide an additional range of configuration options. Visual aid 100b includes a bracket 154 that is affixed to the top end of the telescoping portion 109 with a screw and extends laterally to pivotally connect to mirror 130 through a hinge 152. Hinge 152 permits the mirror 130 to tilt upward or downward about 90° to a select a position from a range that extends from the mirror axis 138 being parallel with base axis 128 (i.e. mirror 130 facing downward) to the mirror axis 138 of being perpendicular to the base axis 128 (i.e. mirror 130 facing to the side).

FIG. 1F shows an alternate embodiment of a visual aid 100c that includes an 8 inch long, flexible tubular portion 164 adapted to have an adjustable shape that may range from having a straight longitudinal axis to being bent with one or more curve portions having a radius as small as 3 inches.

An enlarged view of a portion of the telescoping portion 109 is shown in FIG. 1B, which includes an optional ruler 119 in the form of markings located along the telescoping portion 109 of the support 110 that provide a visual indication of length. Ruler 119 provides a handy tool for measuring the height of the trailer hitch. In many hitching situations, the ability to accurately measure the height of a trailer hitch is advantageous and the integration of the ruler 119 with visual aid 100a eliminates the need for a separate device to measure height.

Two alternate embodiment of an visual aid 100d, 100e are shown FIGS. 2A and 2B, that further provide additional possibilities for positioning the mirror 130a and increase the range of suitable target surface. Visual aid 100d, shown in FIG. 2A, includes a elongated support 110a, an enhanced base 120a and a round mirror 130a. Support 110a is similar to the support 110 shown in FIG. 1A, but is further comprised of a hinge 223 that pivotally couples the base 120a to the lower end 117 of support 110a, which allows the elongated support 110a to be selectively pivoted in the radial direction indicated by reference F allowing the angle A₁, between the lower exposed planar surface 126a and the longitudinal axis of telescoping portion 109 to be selected from the range of 0° to 180°. Hinge 223 also includes a locking screw 423. The angle A₁ may be fixed by rotating the locking screw 423.

Visual aid 100e, shown in FIG. 2b, includes a support 110b that is comprised of a flexible tubular portion 220 that may be selectively bent, in any direction, on a curve having a diameter as small as 3 inches. The shape of flexible tubular portion 220 can be selected to be primarily strait or alternatively with one or multiple bends. The shape of flexible tubular portion 220 may be selected to determine the horizontal and vertical distance between mirror 130a and base 120a as well as the angular relationship between mirror axis 138 and the lower exposed planar surface 126 of base 120a.

The alternate embodiment of base 120a, that is employed by visual aids 100d, 100e, provides visual aid 100d, 100e with increased resistance to tilting when installed. Aspects of the present invention, embodied in base 120a, provide for increased resistance to sliding and tends to reduce the likelihood of damage to the target attachment surface. FIG. 2C depicts a lower view of base 120a. FIGS. 2D and 2E show the same cross sectional view of the base 120a in two different relationships to a target attachment surface 290. Base 120a is comprised of a thin, cylindrical magnet 122a, a flat circular cover 121a, and a flat, donut shaped rubber pad 224. Magnet 122a is similar to previously described magnet 122 and includes a lower exposed planar surface 126a. Magnet 122a has a 3.5 inches outer diameter. Pad 224 has a 5.5 inch outer diameter, an approximately 3.5 inch inner diameter, and an exposed lower planar surface 127. Pad 224 and magnet 122a are in coaxial arrangement, each with the upper planar surface filmily adhered to the lower surface of cover 121a. Pad 224 has a thickness that is approximately the same as the thickness of the magnet 122a.

FIG. 2A shows base 120a secured to a planar attachment surface 290. After being secured to trailer or hitch, base 120a may be removed by tilting the base 120a as shown in FIG. 2e in order to break the magnetic bond to the target attachment surface 290. As the visual device 100d, 100e is tiled to break the magnetic bond, a portion of the exposed outer surface 226 of the pad 224 functions as the fulcrum 250. The material comprising pad 224 is advantageously selected to be resilient so that it resist scratching of the attachment surface 290. Also pad 224 has a larger diameter than magnet 122 and this results in an increased distance R between the fulcrum and the base axis 128 then would occur if the pad 224 was absent. Increasing the distance R tends to further inhibit undesirable tilting of visual aid 100d, 100b after being installed.

Alternative embodiments of pad 224 may have a lower exposed surface 127 that extends 50 to 125 thousandths of an inch beyond the lower exposed surface 122 of magnet 120. The material comprising a pad 224 that extends beyond magnet must be sufficiently compressible, such as sponge rubber or the like, so that the lower exposed surface 122 of magnet 120a makes good contact with the target attachment surface 290 when installed. The thickness of pad 224, the texture of the exposed surface 127, and the resiliency and compressibility of the materials comprising a pad 224 of the present invention may be selected for some intended uses such that the pad tends to increase the friction between the base and a smooth target attachment surface reducing the tendency for visual aid 100d, 100e to slide laterally. Increased friction is beneficial or situations where visual aid 100d, 100e is installed on a smooth inclined surface.

FIGS. 3a through 3c illustrate a visual aid 100f embodying the principles of the present invention, which includes an integrated warning mechanism capable of warning an operator of a towing vehicle that the towing vehicle has become into close proximity to the trailer. Visual aid 100f is similar to the previously described embodiment 100a (shown in FIG. 1A), but is further comprised of a visual indicator 371, which is in this embodiment is implemented with a red light 371 (light bulb encased in translucent red plastic). Visual aid 100f is also comprised of a distance detector 352a, 352b. A basic distance detector 352a is shown in FIG. 3A. An enhanced distance detector is shown in FIGS. 3B, 3C and FIG. 5, that includes an extension 380 adapted to increase the usability of the warning mechanism. Distance detectors 350a, 350b are based on low-cost mechanical solutions; however, well-known, electro-mechanical solutions are also suitable for some applications.

Visual aid 100f is further comprised of batteries (not shown) that are optionally disposed in the base 120a and a 3 foot electrical cord 351 that links the detector 352a, 352b to the base 120a. Both alternate embodiments 352a, 352b of a detector include, a small magnetic strip 353 that is disposed on detector 352a, 352b to provide removable attachment to a magnetic sensitive surface. Alternate embodiments of the present invention provide adhesive for permanently affixing the detector 352a, 252b to a selected location.

Each alternate embodiments 352a, 352b of a detector include a particular version of an electrical, two-pole, momentary switch 351 (shown only in FIG. 3C) that electrically couples the batteries, and light bulb 371, in series, via a pair of electrical conduits (not shown) that route through the support 110 and the 3 foot electrical cord 351. Switch 351 includes a button 354 that response to being pressed by turning the red light bulb 371 on. In operation, detectors 350a, 350b may be selectively positioned so that the button 354 is pressed when the towing vehicle and trailer become a predefined distance from the other. Optionally, the electrical cord 351 may include connectors for removing the cable when it is not being used.

Detector 352b includes an extension 380 that may be adjusted to increase the spatial range detector 350b is sensitive to and provides greater options for configuring visual aid 100f as will be described latter. Suitable extensions may take many forms. In the embodiment of a detector 352b, extension 384 is implemented as a 14 inch long bar bent, at a point 3 inches off longitudinal center, into a “V”-shape having a 115° angle and composed of resilient material such as, for example, a 3/16 diameter bar of an aluminum alloy encompassed within a thin plastic sheath.

Detector 352a is further comprised of a case 391 and a helical spring 362 that is mounted in case 391 and disposed to exert pressure tending to move switch holder 393 toward position P₃ shown in FIG. 3C. Extension 380 is mechanically coupled to switch 351 through a bracket assembly 387 that includes a arm section 394. Sufficient force to overcome the weak compressed spring 361, particularly directed, will cause arm section 394 of bracket assembly 387 to move (in the direction indicated by reference M) a distance D₁ (0.25 inches) from position P₅ to position P₆. This action causes arm section 394 to press on button 354, closing switch 351 to turn the light bulb 371 on. After arm section 394 moves into position P₆, continued force, sufficient to overcome the stronger helical spring 362, causes the switch holder 393 to move (in the direction indicated by reference N) from position P₃ towards position P₄. The sensitivity range of detector 352b corresponds to the distance D₂ between positions P₃ and P₄ illustrated in FIG. 3C. The sensitivity range in this embodiment is 3 inches, however, sensitivity ranges from 3 to 8 inches are generally suitable for most towing applications. The sensitivity range is further expanded by the ability of the extension 384 to bend under pressure to have an angle that is less than 115° as shown in FIG. 3B by alterative position P₂. The sensitivity range is effectively increased by the distance D₃ between extension 384 in the uncompressed state (position P₁) and extension 384 in the compressed state (position P₂).

Detector 352b is further comprised of a locking screw 385 that may be rotated to selectively fix the position of extension 380 with respect to the bracket assembly 387. When locking screw 385 is in the unlocked position, the position of the extension 374 is adjustable by selectively sliding the extension in the direction indicated by reference K or rotated in the radial direction indicated by reference J. An exemplary operation is described later in connection with FIG. 5.

FIGS. 4 and 5 illustrate visual aids 100d, 100f of the present invention installed in a manner advantageous to the operator of a towing vehicle 900, 700 maneuvering the towing vehicle backwards to connect a towing vehicle 900, 700 to trailer 800, 600. A ball type hitch component 973, 773 on the rear of the towing vehicle 900, 700 is to be vertically aligned with a corresponding socket type component 864, 664 on the forward portion 813, 613 of a trailer 800, 600. Thereafter, the forward portion 813, 613 of the trailer 800, 600 can be lowered so that the ball 973, 773 is received into the socket 864, 664 connecting towing vehicle 900, 700 to trailer 800, 600.

FIG. 4 shows part of an exemplary boat trailer 800 and towing vehicle 900 as the towing vehicle 900 is being moved backwards. Visual aid 100f, as described in connection with FIG. 3A, is installed to assist the driver in determining when the correct alignment between hitch components 864, 973 is achieved. Visual aid 100f is removably attached to an upward facing surface 815 located on the forward portion 813 of the trailer 800.

The trailer 800, in this application includes a mechanism 836 for adjusting the distance the trailer hitch component 864 resides above the ground. Visual aid 100f, which includes the optional ruler 119 illustrated in the detail of FIG. 1B, may be placed horizontally with the base 120 on the ground (not shown in this position) to provide a handy tool to measure the height of the trailer hitch component 864 while the height is being adjusted.

After the height if the hitch component 864 is set, visual aid 100f may be secured to trailer 800, as shown in FIG. 4, by placing the lower exposed magnet surface 126 of base 120 in magnetic engagement with the upward facing surface 813, which may be slightly inclined. The axis 138 of mirror 130 may be positioned so that reflective surface 132 directs a selected field of view, comprising an image of the trailer hitch component 864, to the line of sight 442 of an observer sitting in the driver's seat of the towing vehicle 900. The projected image indicates to the operator of the towing vehicle 900 when the hitch components 864, 973 are properly aligned.

Visual aid 100f incorporates a warning mechanism with an enhanced distance detector 352b and a light bulb 371 as described earlier in this disclosure. The distance detector 352b is secured to a side surface 814 on the forward most portions 813 of trailer 800 and the extension 380 is adjusted to where a point 381 on the extension 380 will contact the rear portion 975 of the towing vehicle 900 as the vehicle 900 is maneuvered backwards. The distance detector 352b may be configured to indicate when the towing vehicle 900 has moved into the correct position. Alternatively the position detector 352b may be configured (not shown in this configuration) to warn the operator when the towing vehicle 900 has moved in to an undesirable position.

As the towing vehicle 900 is moved further backwards (not shown in this position), a rear surface 975 of towing vehicle 900 makes contact with the extension 380 and the light bulb 371 turns on. The towing vehicle 900 is permitted to continue to move backwards an additional 3 inches and the light bulb 371 will remain on; however, if the towing vehicle 900 moves backwards more than 3 inches, the distance detector 352b may be dislodged from the trailer hitch 800.

FIG. 5 depicts a visual aid 100d that is described earlier in connection with FIG. 2A. Visual aid 100d is shown installed on a non-horizontal surface 726 of a towing vehicle 700. To install visual aid 100d, base 120a is placed in close proximity to the target attachment surface 726. The position of mirror 130a may also be adjusted to select the desired position and orientation of mirror 130a so that a field of view comprising an image of the towing vehicle hitch component 773, is directed to the line of sight 442 of an observer sitting in the driver's seat of the towing vehicle 700. The position of mirror 130a may also be adjusted to position the center-of-gravity of visual aid 100d such that the force of gravity does not dislodge base 120a from the target attachment surface 726. The position of mirror 130 is determined by: (1) adjusting the length L of support 110a, (2) selecting the orientating the mirror's axis 138, and (3) by rotating the base 120 about its axis 128 to select the desired angular orientation of the visual aid 100d. The base 120a may be selectively rotated about its axis 128 by tilting base 120a (as shown in FIG. 2E) to break the magnetic attachment grip, rotating the base to the desired orientation, and then placing the base 120a flat to magnetically reengage the target attachment surface. As the towing vehicle 700 is moved backward, the forward extension portion of a trailer 613 enters the field of view projected to the observer and provides an indication of when the hitch components 773, 664 are properly aligned.

I claim:

1. A visual aid for assisting the operator maneuvering a towing vehicle to align a first trailer hitch component located on the rear of the towing vehicle with a second trailer hitch component located on a forwardly extending member of a trailer, or the like, to be towed; wherein one of, the towing vehicle and trailer, is comprised of one or more suitable target surfaces disposed to engage in a magnetic bond with an adjacently positioned magnet; said visual aid comprising:
a mirror with a reflective surface defining a mirror axis as lying generally perpendicular to the portion of the reflective surface proximal to the center of mirror;
a magnet having a generally cylindrical shape defining an axis, the magnet has an exposed circular surface lying essentially in a plane traverse to said magnet axis; wherein the magnet is adapted to engage in a magnetic bond with a selected suitable target surface by being placed adjacent to the target surface, wherein the magnet is movably positionable at within the greater area of said suitable target surface; and wherein the angular orientation of the magnet with respect to the target surface is selectable from a range of options;
a support for adjustably affixing the mirror to the magnet; wherein the mirror is movably positionable, in relationship to the magnet, within a fixed range of position options; and wherein the angle of the mirror axis in relationship to the magnet axis is adjustable within a fixed range of angle options; wherein, when the magnet is in engaged with the target surface at select position and angular orientation with respect to the target surface, the relative position of mirror and magnet is selectable and the mirror orientation is selectable to direct a field of view comprising an image of one of the trailer hitch components to the line of sight of an observer sitting in the driver's seat of the towing vehicle.

2. The visual aid of claim 1, wherein said fixed range in which the mirror is movably positionable in relationship to the magnet, includes position options spanning a length of at least 2 feet along a line lying parallel with the axis of magnet.

3. The visual aid of claim 2, wherein said fixed range in which mirror is movably positionable in relationship to the magnet, further includes position options lying essentially on a line perpendicular with axis of magnet and spans distance of at least 2 feet.

4. The visual aid of claim 1, wherein said fixed range in which mirror is movably positionable in relationship to the magnet, further includes position options lying within the area of a plane lying generally parallel with a plane intersecting the axis of magnet, the area bounded a first and second radial distance, spaced apart at least 2 feet, and by a another plane that lies coincident with the expose circular surface of magnet.

5. The visual aid of claim 4, wherein the range, in which the angular orientation of the magnet with respect to the target surface is selectable, is 0° to 360.

6. The visual aid of claim 1, further comprises a resilient pad formed with a cylindrical void, defining a central axis, and a lower planner surface lying traverse to said central axis; and wherein pad is affixed to magnet in a fixed coaxial arrangement with the magnet located generally within the cylindrical void of the pad, and wherein the pad is adapted to function as a fulcrum as the magnet disengages from magnetic bond with the target surface by tilting the axis of magnet.

7. The visual aid of claim 6, wherein, when the magnet is disengaged from target surface, the lower planner surface of the resilient pad extends at least 50 thousands of an inch beyond the exposed circular surface; and wherein the pad is comprised of compressible material adapted to permit lower surface of magnet to engaged with the target surface in a magnetic bond by being placed adjacent to the target surface.

8. The visual aid of claim 7, wherein the lower exposed planar surface of pad is disposed to resist movement of magnet, when the magnet is engaged with the target surface, in a direction lateral to the magnet axis, by frictionally engaging target surface.

9. The visual aid of claim 1, further comprising an integrated warning mechanism that is adapted to be selectively operated to monitor and provide a visual indication of whether the towing vehicle and the trailer are within a predefined distance of the other.

10. The visual aid of claim 9, wherein the integrated warning mechanism is adapted to be selectively operated to monitor and provide a visual indication of whether the towing vehicle and the trailer are within a distance of the other, which is within a predefined distance range of at least 3 inches.

11. The visual aid of claim 9, wherein the warning mechanism further includes a distance detector that is adapted for removable attachment to a select location on one of, said towing vehicle and said trailer, to detect when the other one of said, towing vehicle and said trailer are within the predefined distance range of each other.

12. The visual aid of claim 1, wherein the orientation of mirror axis in relationship to magnet axis is adjustable within a fixed range of orientation options that include options in which the reflective surface of mirror faces in the general direction towards the magnet with mirror axis deviating from the magnet axis by an angle that spans at least a 15° to 75° range.

13. The visual aid of claim 1, wherein the support includes a telescoping portion.

14. A visual aid for facilitating hitching a trailer, or the like, to the rear of a towing vehicle, said hitching includes maneuvering said towing vehicle, backwards, into a desired position with respect to said trailer; said visual aid comprising:
a mirror, with a reflective surface;
a support structure having a first and a second opposing ends; the mirror is pivotally affixed to the second end of the support structure in a manner that allows the orientation of mirror to be selectively adjusted; and wherein the second end is movably positionable, in relationship to said first end, within a fixed range of position options that span a length of at least 2 feet;
a magnet affixed to the first end of said support structure, magnet is adapted to be removably attached to a selectable magnetic-sensitive surface located on one of the, trailer and towing vehicle; wherein, when the magnet is attached to a target surface, the relative position between first and second opposing ends of support is selectable and the orientation of mirror is adjustable to direct a field of view comprising an image of one of the trailer hitch components to a particular line of sight.
a visual indicator that provides two visual states is affixed to support structure in the general proximity of mirror; and
a distance detector adapted to be mounted to a target surface on a first one of, the towing vehicle and said trailer, to make a determination of whether a second one of, the towing vehicle and said trailer, is positioned within a predefined distance of the first one; and wherein the distance detector, during operation, is coupled to the visual indicator to select one of the two visual states based on said determination

15. The visual aid of claim 14, wherein the visual indicator includes a light-bulb and wherein the one of said visual states correspond to the light-bulb being on and the other of said visual state corresponds to the light-bulb being off.

16. The visual aid of claim 14, wherein the distance detector, when mounted, is further adapted to make contact with the second of, the towing vehicle and said trailer, in the event that the second one of, the towing vehicle and said trailer, is positioned within the predefined distance of the first one.

17. The visual aid of claim 14, wherein said distance detector further a magnetic strip fixedly attached to the case for mounting distance detector in a removable manner to the target position.

18. The visual aid of claim 14, wherein the distance detector is capable of detecting whether the second one of, the towing vehicle is positioned within a range of at least three inches in length.

19. A method for directing a selected field of view, comprising an image of a trailer hitch component, to the line of sight of an observer sitting in the driver's seat of a towing vehicle, said method comprising:
providing a visual aid comprising a mirror with a reflective surface defining a mirror axis and a magnet having a generally cylindrical shape defining a central axis, wherein the magnet has an exposed circular surface lying essentially in a plane traverse to the central axis; wherein magnet is adapted to engage in a magnetic bond with a suitable target surface by being placed adjacent to a selected position on the target surface, wherein the angular orientation of magnet with respect to the target surface is selectable from a range of options, and wherein magnet is movably positionable with in the area comprising said suitable target surface; and wherein visual aid is further comprised of a support adjustably affixing mirror to magnet; wherein mirror is movably positionable, in relationship to the magnet, within a fixed range of position options; and wherein the angle of mirror axis in relationship to magnet axis is adjustable within a fixed range of angle options;
placing magnet, adjacent to a selected target surface to engage target surface in a magnetic bond; and
selecting the angular orientation of mirror with respect to a target surface, a relative position of mirror and magnet, and an angular orientation of mirror, to direct a selected field of view, comprising an image of a trailer hitch component, to the line of sight of an observer sitting in the driver's seat of a towing vehicle.

20. The method of claim 19, wherein the fixed range of positions in which mirror is movably positionable, in relationship to the magnet, includes position options lying within a “C” shaped area generally parallel with a plane intersecting the axis of magnet, and bounded a first and second radial distance spanning at least 2 feet and by a plane lying coincident the expose circular surface of magnet.
